(19) United States
(12) Patent Application Publication
(10) Pub. No.: US 2006/0257080 A1
(43) Pub. Date: Nov. 16, 2006

(54) Methods and devices for alignment of optical components

(76) Inventor: Paul Rosenberg, Sunnyvale, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/127,937

(22) Filed: May 12, 2005

(51) Int. Cl. G02B 6/36

(52) U.S. Cl. 385/92

(57) ABSTRACT

An optical subassembly includes a housing and a port configured to be coupled to each other. Located within the housing is an opto-electronic device having an alignment error relative to a reference of the housing. Located within the port is an optical element having an alignment error relative to a reference of the port, such that an error vector and error angle associated with the optical element corresponds with an error vector and error angle associated with the opto-electronic device. The port is rotated relative to the housing such that a predetermined rotation of the port corresponds with substantial coaxial alignment of the optical element and the opto-electronic device.

### BACKGROUND OF THE INVENTION

1. The Field of the Invention

The present invention relates to systems for optical communication. More particularly, the present invention relates to an optical sub-assembly used in a system of optical communication.

2. Related Technology

Optical networking and telecommunication is increasingly employed as a method by which information can be reliably transmitted. Networks employing optical networking and telecommunication technology are known as optical communications networks, and are marked by high bandwidth and reliable, high-speed data transmission.

Within optical communications networks, optical transceivers are employed to receive and transmit optical data signals, to convert optical data signals to electrical data signals, and to convert electrical data signals into optical data signals. Important components in an optical transceiver include the transmitter optical subassembly (TOSA), the receiver optical subassembly (ROSA), and the printed circuit board (PCB). The TOSA converts an electrical data signal to an optical data signal, which is subsequently coupled to an optical fiber. A laser is often used in optical data signal transmission systems to produce a strong optical data signal appropriate for traveling longer distances. By contrast, the ROSA typically uses a photodiode, coupled with a high gain amplifier, to convert an optical data signal into an equivalent electrical data signal.

Use of the TOSA and the ROSA in optical communications systems allows two-way communication between two endpoints which use different types of signals. That is, a TOSA and ROSA facilitate communication between one side of the communications network which uses optical data signals and the other side of the communications network which uses electrical data signals. As mentioned above, a PCB is also included in optical transceivers used in optical communications systems. The PCB couples with a connector extending from the TOSA and/or a connector extending from the ROSA. In the case of a TOSA, the connector may connect an active device, such as a laser, with circuitry on the PCB. In the case of a ROSA, the connector may connect a photo-diode, or other device, with circuitry on the PCB.

In the assembly of typical TOSAs or ROSAs, a precision alignment must be performed to couple an active device or other opto-electronic component to an optical port that is connected to an optical fiber. Alignment of an opto-electronic component with a fiber received in an optical port is important to ensure efficient coupling of the optical data signal into the fiber, thereby preserving the strength of the optical data signal. There are various ways to approach alignment of the subassembly components. Depending on the nature of the device and/or intended application, different alignment strategies can apply.

One alignment strategy is active alignment. Active alignment involves configuring components to minimize optical loss while the output of the laser is monitored. For a TOSA, the configuration to minimize optical loss is achieved by applying electrical power to a laser and adjusting the position of the laser relative to an optical fiber until a target level of optical power is achieved. For a ROSA, light is transmitted through an optical fiber and the position of the optical fiber is adjusted relative to a detector of the ROSA until a target level of optical power is sensed at the detector. Although active alignment processes can be effective in achieving a high level of accuracy in aligning optical components with a laser, such processes are expensive and time consuming to undertake.

A passive alignment process can also be used to align optical subassembly components. Unlike an active alignment process, known passive alignment techniques involve aligning optical components without monitoring the output of a laser or signal source which is coupled to the optical components. Several techniques for passive alignment have been developed, including using precision features, such as lithographically formed pits and/or grooves to aid in positioning and aligning optical components. In an alignment technique involving the use of grooves, grooves may be etched into a microbench fabricated from silicon to position and hold the optical fiber in place, with respect to elements such as lasers, photodiodes, lenses, or other components in the optical system.

Another known technique for passively aligning optical components with lasers involves placing precision bumps on the optical components, through a process such as solder deposition, and matching the bumps on the optical components to corresponding pads, pits, or bumps on a system assembly substrate in order to make relative positioning of system components precise and predictable. Although some passive alignment processes can be less expensive than active alignment processes or methods, passive alignment processes may sacrifice the integrity of the signal transmitted through optical components. Passive alignment approaches also often have hidden costs that result from the need to fabricate extremely precise components, and to inspect those components in order to determine if they are suitable for production use. In short, known passive alignment processes such as those noted above are often unable to significantly reduce the cost of manufacturing while at the same time providing efficient and reliable alignment of optical components.

In addition to active alignment and passive alignment processes for aligning optical subassembly components, vision aided alignment techniques are also employed. Vision aided alignment processes position and align active devices by using a visual technique such as pattern recognition. As with passive alignment, visual alignment techniques often fail to provide optimal signal throughput, or an optimal level of laser or signal source strength transmitted through the optical components.

Hybrid approaches to the alignment of optical components employ machine visual and/or mechanical registration to aid in approximate positioning of sub-assembly components, followed by an active alignment to optimize the final position. Again, however, such techniques fail to efficiently provide optimal strength of the signal transmitted through the optical components, and are time-consuming and expensive, making these techniques unsuitable for low cost products and systems.

### BRIEF SUMMARY OF AN EXEMPLARY EMBODIMENT OF THE INVENTION

In view of the foregoing, and other problems in aligning optical components, what is needed are new methods and devices for aligning components of optical subassemblies that help reduce the cost of manufacturing optical devices while providing for quick and reliable alignment of the optical components. These methods and devices should also be flexible so as to accommodate various sets of circumstances that may arise in connection with alignment evolutions.

In an exemplary embodiment of the invention, components of an optical subassembly are attached and aligned using a method of joining components which have specified characteristics. A housing of an optical subassembly includes an opto-electronic device positioned within the housing. When the opto-electronic device is positioned within the housing, it is typically the case that the opto-electronic device is not precisely centered or positioned within the housing. This imprecision in placement is a reflection of inherent limitations in the manufacturing process. The displacement between the desired, and actual, position of the opto-electronic device may also be referred to herein as an alignment error.

To compensate for the displacement of the opto-electronic device from a reference point within the housing, the optical element of a mating port is configured and designed so that the optical element has a specific eccentricity in relation to the center of the port. The eccentricity of the optical element is known, as is the alignment error of the opto-electronic device. Before a port is coupled with a housing, the alignment error of the opto-electronic device is taken into account so that a port with an optical element having an eccentricity corresponding to the alignment error of the opto-electronic device is selected.

Either before or after the port is press fit into the housing, the port is then rotated, or its position relative to the housing is otherwise modified, until the optical element and the opto-electronic device are substantially coaxially aligned. Selection of a port that includes an optical element having an eccentricity which corresponds to the alignment error of the opto-electronic device, enables the optical element and opto-electronic device to be accurately aligned by movement of the port until the optical element of the port is aligned with the opto-electronic device of the housing.

These and other aspects of embodiments of the present invention will become more fully apparent from the following description and appended claims.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 is an exploded view illustrating an exemplary optical subassembly that includes an optical fiber, port, housing, optical element, and opto-electronic device with reference to the x, y, and z axes;

FIG. 2 is a cutaway view illustrating the optical subassembly including the port, housing, optical element and opto-electronic device with reference to the x, y, and z axes;

FIG. 3 is a top view of the housing illustrating the opto-electronic device positioned within the housing;

FIG. 4 is a top view of the port illustrating the optical element positioned within the port;

FIG. 5 is a top view of the port and the housing, illustrating the optical element and the opto-electronic device when the port has been press fit into the housing;

FIG. 6 is a top view that provides further details concerning an exemplary port and housing; and

FIG. 7 illustrates an exemplary process for aligning optical components.

### DETAILED DESCRIPTION OF EXEMPLARY EMBODIMENTS OF THE INVENTION

Exemplary embodiments of the present invention are concerned with a design and process for precision alignment of opto-electronic devices, contained within an optical housing, and optical elements, such as a lens, contained within an optical port. The port and housing are configured with specific characteristics to provide an efficient and cost effective method for alignment of the optical element and the opto-electronic device.

One exemplary optical subassembly includes a housing, and a port coupled to the housing. The housing includes an opto-electronic device which is located within the housing near a reference point, which is, in many cases, a central axis of the housing. The optical element, located within the port, is fabricated to have a specified eccentricity relative to a reference point of the port, such as a central axis of the port. Before the port is coupled to the housing, a port is selected such that the eccentricity of the optical element of the port corresponds to the displacement of the opto-electronic device from a reference point within the housing. By selecting a port having an optical element with an eccentricity, or other misalignment or deviation, corresponding to the alignment error of the opto-electronic device of the housing, the optical element and the opto-electronic device can be aligned with each other when the port is rotated.

Rotation occurs until the optical element and the opto-electronic device, due to the correspondence of the eccentricity of the optical element and the alignment error of the opto-electronic device, come into alignment with each other. The port and housing are joined by press fitting a port engagement element into a housing engagement element, or otherwise mating the port and housing through the use of corresponding complementary structures, constructed on the interior wall of a housing cavity, and the port is then rotated until the optical element and the opto-electronic device are substantially coaxially aligned with each other. The port and housing may also be rotated so that the optical element and the opto-electronic device are substantially coaxially aligned with each other before the port and housing are joined. By aligning the optical element and the opto-electronic device in this way, an effective, low-cost method for efficient optical coupling within the optical subassembly is achieved. In at least some cases, the alignment is aided through various visual processes where, for example, alignment is determined with reference to the efficiency of optical coupling between a source or detector, and an optical fiber.

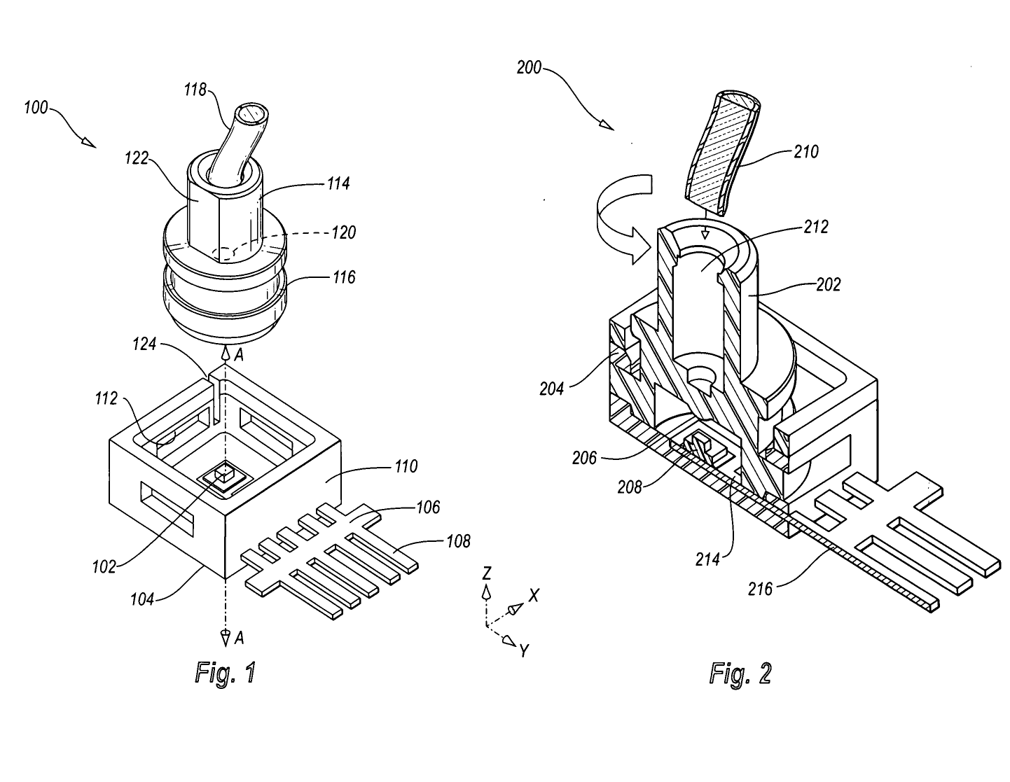

Referring now to FIG. 1, optical system 100 includes an optical component, exemplified as opto-electronic device 102, located within housing 104. In the most general sense, an optical component includes anything within optical system 100 having an optical attribute, and would apply to opto-electronic devices such as, for example, a laser, photodiode, photodetector, and any other active or passive optical device. The term “optical component” also encompasses optical elements such as, for example, a lens, a reflector, or any other optical element.

The opto-electronic device 102 included in optical system 100 is positioned in housing 104 within a specified radial tolerance, or allowable deviation. In some cases, specific radial tolerance is measured with reference to central longitudinal axis AA of the housing 104, but could relate to other references also. Exemplary references may include a reference point in a two-dimensional plane or three dimensional space, or a reference axis. Housing 104 may be constructed of any number of materials, including metal-based materials, plastics, thermoplastics, silicon, and other materials or combinations of materials. Examples of opto-electronic devices 102 which could be positioned within housing 104 include lasers, photodiodes, and any other active or passive optical device.

Opto-electronic device 102 is carefully placed within the housing 104 near the reference point, with the specified tolerance allowing for the inherent imprecision in the placement process. If optical system 100 is a TOSA, for example, the opto-electronic device 102 comprises an optical transmitter such as a laser, for example. If optical system 100 is a ROSA, the opto-electronic device 102 comprises an optical detector, such as a photodiode. As mentioned previously, it is anticipated that opto-electronic device 102 is placed in an x-y plane of the housing 104 within a specified tolerance relative to the central longitudinal axis AA reference. The placement of the opto-electronic device 102 within the housing 104 in a position that does not exactly correspond to a reference point within the housing 104, such as the center of the housing 104, may also be referred to herein as an alignment error.

When positioned in the housing 104, opto-electronic device 102 is electrically connected to a first end of a connector 106, by way of signal traces (see FIG. 2). More specifically, the first end of connector 106 is located within the housing 104 and connects to signal traces within the housing 104, while the second end 108 of connector 106 extends from a side 110 of housing 104. Second end 108 of connector 106 extends from a side 110 of housing 104 so that second end 108 can be connected to signal traces on a PCB (not shown).

With continuing reference to FIG. 1, housing 104 also includes housing engagement element 112 of the housing 104. In one exemplary embodiment, engagement element 112 takes the form of a slot defined by the housing 104. When port 114 is pressed into housing 104, port engagement element 116 engages housing engagement element 112 so that port 114 is rotatably secured within the housing 104. In other words, bottom portion 116 of port 114 snaps into engagement element 112 to rotatably secure the port 114 within the housing 104. Port 114 may be fabricated using any number of materials or combinations of materials, such as, for example, plastics, thermoplastics, metal-based materials, glass, or other materials. Port 114 may also be configured to have any number of shapes, such as, for example, a circular or polygonal shape.

Although a circular shaped port 114 can be smoothly rotated within housing 104, a polygonal shaped port may also be rotated within housing 104. A polygonal shaped port has a defined number of possible rotation positions, with the number of rotation positions limited to the number of sides of the polygon. For example, if the port is square shaped, the port has four possible rotation positions within housing 104. Each rotational movement of a polygonal shaped port is defined by rotating the port to the next consecutive rotational position, which corresponds to the next consecutive side of the polygon. For example, when a square-shaped port is rotated one rotational movement, the square-shaped port is rotated from a first side of the square to a second consecutive side of the square. Unlike a circular-shaped port which would have an infinite number of rotational positions, a square shaped port has only four possible rotational positions.

Due to the angular shape of a polygonal port, some embodiments of the polygonal port are required to be lifted out of the housing 104 to enable changes to the position of the port relative to the housing. Polygonal ports are rotated or otherwise repositioned in defined increments, unlike a circularly shaped port 114 which can be continuously rotated without interruption.

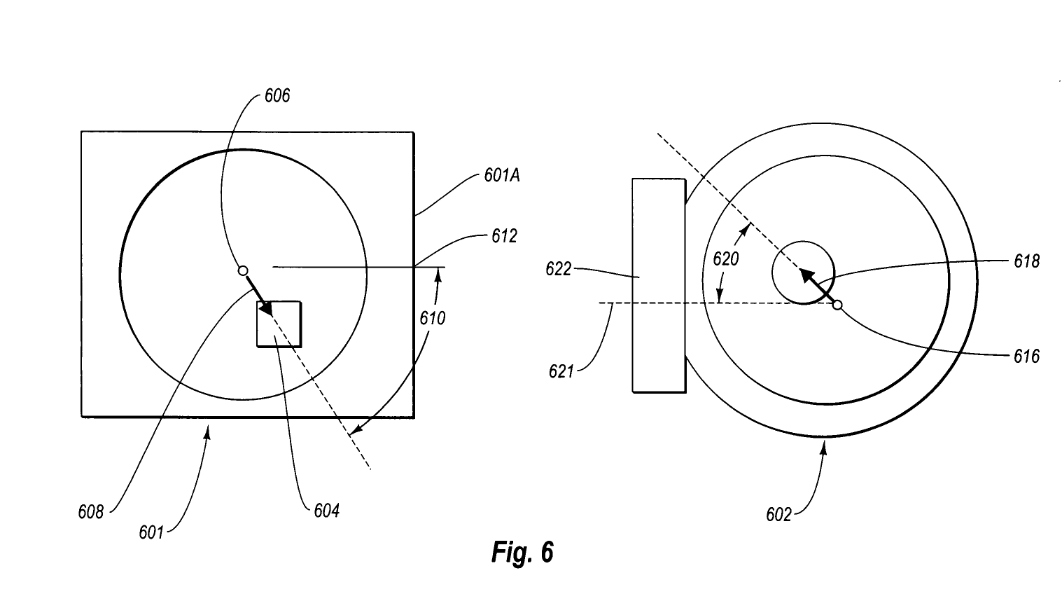

With continued reference to FIG. 1, port 114 further includes an optical element and an optical fiber 118 received into the port 114. The optical element performs a desired operation on an optical signal traveling through port 114. Coupling the signal between the opto-electronic device 102 and the optical fiber 118 is an example of an operation which may be performed by the optical element. In one exemplary embodiment, the optical element is a lens 120, shown in FIG. 1 in phantom. Lens 120 cooperates with opto-electronic device 102 to transmit or receive a signal through the port 114. If optical system 100 is a ROSA, a signal enters port 114 through optical fiber 118. When port 114 is manufactured, lens 120 is positioned within port 114 with a specified eccentricity, meaning that lens 120 is intentionally positioned in the x-y plane to be offset a predetermined distance with respect to a reference point or axis of port 114. In the exemplary embodiment shown in FIG. 1, the reference of port 114 is axis AA. The eccentricity of lens 120 is known, as is the alignment error of opto-electronic device 102. Alignment of lens 120 of port 114 and opto-electronic device 102 of housing 104 is discussed in further detail with reference to FIG. 6 below.

An additional feature incorporated into housing 104 in one embodiment of the invention is slot 124. Slot 124 is a thin opening extending from the top of housing 104 to a point on the wall of housing 104 near the bottom of housing 104. In this way, slot 124 allows housing 104 to spring open slightly as needed when port 114 is press fit into housing 104. Slot 124 thus provides press compliance while maintaining the cylindrical reference geometry of port 114. Of course, other structural features of comparable functionality to slot 124 could alternatively be employed in exemplary embodiments of the invention.

When a port 114 is selected to be coupled to housing 104, the eccentricity of lens 120 of port 114 is matched to the alignment error of the opto-electronic device 102 contained within housing 104. Different housings will have opto-electronic devices with different alignment errors. A first housing having an opto-electronic device with a particular alignment error will be coupled to a first port with a lens having a corresponding eccentricity. A second housing, having an opto-electronic device with another alignment error, would correspondingly be coupled to a port with a lens having an eccentricity corresponding to the alignment error of the opto-electronic device of the second housing. Ports reflecting a full range of eccentricities corresponding to a full range of alignment errors can be manufactured as necessary to suit housings with corresponding alignment errors.

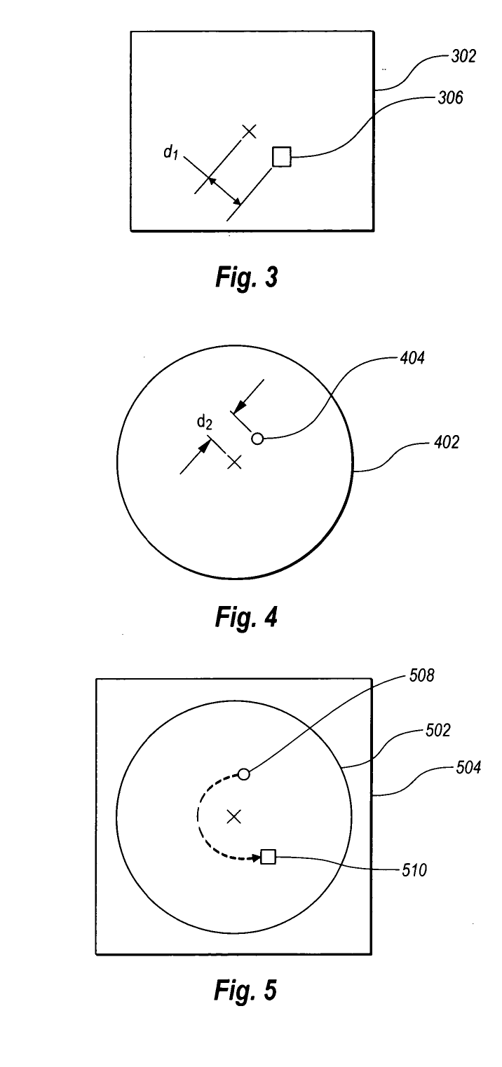

By matching opto-electronic device 102, having a specific alignment error, to lens 120, which has a specific eccentricity, port 114 and housing 104 can be joined, and port 114 can be rotated until lens 120 and opto-electronic device 102 are substantially coaxially aligned. As noted above, port 114 and housing 104 may be rotated, or the positions of port 114 and housing 104 may be otherwise adjusted, so that lens 120 and opto-electronic device 102 are substantially coaxially aligned before port 114 and housing 104 are joined together. In one embodiment, ports are color coded, designated with tick marks, or otherwise configured or marked to enable a port of a specific eccentricity to be easily selected for coupling to a specific housing. The marking thus eases selection of a port which will have an optical element of an eccentricity corresponding to an alignment error of an opto-electronic device in the housing. Operation and performance of the port are not altered by the marking. An exemplary alignment process is discussed more fully in relation to FIGS. 3 through 5.

Coaxial alignment of lens 120 and opto-electronic device 102 allows optical system 100 to transmit or receive a signal with substantial strength and light throughput by providing an unobstructed path between an optical fiber 118 and an opto-electronic device 102. Coaxial alignment of lens 120 and opto-electronic device 102 couples a larger amount of the optical signal between one or more optical components and an optical fiber, thus resulting in greater optical coupling efficiency. In one exemplary embodiment, where optical system 100 is a ROSA, an optical signal enters optical fiber 118, passes through lens 120 and is received at opto-electronic device 102. Alternatively, if optical system 100 is a TOSA, the signal is sent from opto-electronic device 102 through lens 120. After passing through lens 120, the signal continues into the optical fiber 118 located at the end of port 114.

While FIG. 1 shows the port 114 and housing 104 before they are joined together, FIG. 2 shows an exemplary embodiment of the invention when the port 114 and housing 104 are engaged. As shown in FIG. 2, opto-electronic system 200 includes port 202 which has been press fit into housing 204. Port 202 includes a lens 206, or other optical element, through which an optical data signal passes when an optical data signal is either transmitted from, or received by, opto-electronic system 200. The lens 206 could be spherical, aspherical, or otherwise shaped or configured, and may comprise a plurality of optical components rather than a single lens.

In addition to including port 202 press fit into housing 204, opto-electronic system 200 also includes opto-electronic device 208 positioned within housing 204. Opto-electronic device 208 is positioned in housing 204 within a specified radial tolerance, or deviation from a specified reference point within the housing. The deviation in the placement of the opto-electronic device 208 is due to an imprecision inherent in the manufacturing process. In the event that opto-electronic system 200 is a ROSA, an optical signal travels through optical fiber 210 and enters port 202 through opening 212. FIG. 2 shows optical fiber 210 disconnected from port 202.

When optical fiber 210 is connected to port 202, the optical fiber 210 is received in the port 202 through opening 212, and the optical signal is transmitted from the optical fiber 210, through lens 206, and received at opto-electronic device 208. At opto-electronic device 208 the optical signal is converted to an electrical signal and is then transmitted through signal traces 214 to connector 216. From connector 216, the electrical signal is transmitted to other components (not shown) of opto-electronic system 200.

In the event that opto-electronic system 200 is a TOSA, an electrical signal is transmitted from electrical components within opto-electronic system 200 to connector 216 and on to signal traces 214. The electrical signal travels through signal traces 214 to opto-electronic device 208, where the electrical signal is converted to an optical signal. The optical signal is transmitted from opto-electronic device 208 through lens 206. Finally, the optical signal travels through opening 212 and is received into optical fiber 210.

As discussed previously with reference to FIG. 1, lens 206 and opto-electronic device 208 are each misaligned to a certain extent relative to corresponding reference points. In the case of the lens 206 located within port 202, the aligned is intentional and calculated to correspond with the misalignment of the opto-electronic device 208 that typically occurs due to imprecision in the manufacturing process. Once the manufacturing of port 202 and housing 204 is completed, port 202 is press fit into housing 204 and then port 202 is rotated until the lens 206 and the opto-electronic device 208 are substantially coaxial. With reference to the x, y, and z axes, the location of opto-electronic device 208 is fixed along the z axis, within housing 204. Either before or after being press fit into housing 204, port 202 is rotated, as shown by the arrow, until the lens 206 and the opto-electronic device 208 are substantially coaxial with each other. More particularly, the rotation of port 202 causes lens 206 to move in the x-y plane of lens 206, which is parallel to the x-y plane of opto-electronic device 208, until lens 206 is aligned with opto-electronic device 208. Determination of the final position of port 202 within housing 204 along the z-axis can be achieved either passively or actively using calculated measurement data.

Referring now to FIG. 3, a top view of housing 302 is shown. The X marks the center of the housing 302, or other specified point within the housing 302 from which opto-electronic device 306 is displaced. When opto-electronic device 306 is positioned within the housing 302, imprecision inherent in the positioning process results in an alignment error, meaning that the position of opto-electronic device 306 does not exactly correspond with the center, or other reference point, of housing 302. The alignment error is shown by displacement d₁ marking the distance from the position of the opto-electronic device 306 to the reference point denoted at X.

In one exemplary embodiment, ports used in the present invention include optical elements, such as, for example, a lens, having a specified eccentricity. When a port is selected for mating with the housing 302, the eccentricity of the optical element contained within the port is matched to the alignment error of the opto-electronic device positioned within the housing. To construct an optical sub-assembly, a port is selected based on the eccentricity of the optical element of the port, and the alignment error of the opto-electronic device positioned within the housing to which the port will be coupled.

When the port is press fit into the housing, the port and/or the housing is rotated and the optical element and the opto-electronic device are gradually moved into alignment with each other through a process of active, passive, or vision aided alignment. By way of example, a camera or other comparable equipment may be employed to aid a visual assessment as to whether two optical components are properly aligned. An exemplary passive alignment process is performed by using the same measurement data that was used to calculate the eccentricity of the optical element. In particular, once the magnitude and direction of the alignment error are known, a port is selected and rotated through a known angle to achieve alignment.

FIG. 4 shows a top view of port 402. Optical element 404 has a specified eccentricity away from the center, marked by an X, of port 402. Distance d₂ is the distance between the optical element 404 and the center, denoted at “X,” of port 402. Port 402 is selected so that distance d₂ is substantially the same as distance d₁, shown in FIG. 3.

FIG. 5 shows port 502 after port 502 has been press fit into housing 504. In the exemplary embodiment shown in FIG. 5, the X indicates the center of both housing 504 and port 502. Initially, optical element 508 may not be coaxially aligned with opto-electronic device 510. Therefore, either before or after port 502 is press fit into housing 504, one of port 502 or housing 504 is rotated until optical element 508 and opto-electronic device 510 are substantially coaxially aligned through a process of active, passive, or vision aided alignment. In the exemplary embodiment illustrated in FIG. 5, port 502 is rotated in a counter-clockwise direction. As port 502 is rotated, optical element 508 follows the path designated by the dotted line until optical element 508 is positioned above opto-electronic device 510, and optical element 508 and opto-electronic device 510 are substantially coaxially aligned. After port 502 has been rotated to align optical element 508 with opto-electronic device 510 and then press fit into housing 504, port 502 and housing 504 may be secured in position relative to each other by a process such as application of a structural adhesive, ultrasonic welding, or any other process of attachment.

As noted above, FIGS. 3 through 5 provide information concerning structures and processes by way of which alignment of optical components may be achieved. Referring now to FIG. 6, details are provided concerning an exemplary embodiment of a housing 601 and port 602 that are configured to facilitate alignment processes. As indicated in FIG. 6, an opto-electronic device 604 is located within housing 601 with a known alignment error, or offset, relative to the center 606 of the housing 601. In FIG. 6, the magnitude of the alignment error, as well as the direction of the alignment error, are shown by error vector 608. This error vector 608 may be calculated in various ways. In one example, the error vector 608 is calculated by using a vision-based coordinate measuring machine (“CMM”) to determine the location of the center 606 (coordinates X1,Y1), and the center of the optoelectronic device 604 (coordinates X2,Y2). The error vector 608 can thus be generally expressed as [(X1−X2), (Y1−Y2)].

Calculation of the error vector 608 also enables determination of an error angle 610. In particular, the error angle 610 is the angle defined by the error vector 608 with respect to the center axis 612 of a side 601A of housing 601.

With continuing attention to FIG. 6, the port 602 includes lens 614 which is offset from the center 616 of port 602. The distance and direction of the offset of lens 614 from the center 616 of port 602 is represented by a known error vector 618. Generally, the magnitude and direction of error vector 618 are substantially equal to the magnitude of the error vector of the housing to which the port is to be joined, in this case, error vector 608 of housing 601. Similar to the case of housing 601, the error vector 614 of the port 602 defines an error angle 620 with respect to a center axis 621 of flat surface 622 of port 602.

When the error vector 608 of housing 601 is determined, port 602 608 is selected for coupling with housing 600, by virtue of the fact that port 602 has an error vector 618 with a magnitude corresponding to the magnitude of error vector 608 of housing 601. Port 602 is then rotated until the flat surface 622 of port 602 is aligned with side 601A of housing 601. When port 602 is rotated so that flat surface 622 of port 602 is aligned with side A of housing 601, the opto-electronic device 604 and lens 614 are substantially coaxially aligned with each other. After alignment has been achieved, the port 602 can then be press-fit into the housing 601.

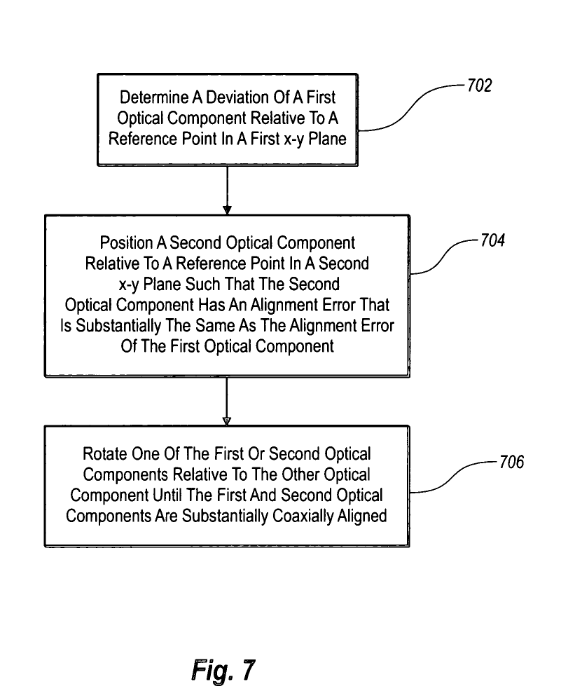

With attention now to FIG. 7, an exemplary process 700 for aligning first and second optical components is shown. First, a deviation of a first optical component relative to a reference point in a first x-y plane is determined, as shown at stage 702. At stage 704, a second optical component is positioned relative to a reference point in a second x-y plane such that the second optical component has a deviation that is substantially the same as the deviation of the first optical component. After the second optical component is positioned, the process 700 is completed as one of the first or second optical components is rotated relative to the other optical component until the first and second optical components are substantially coaxially aligned with each other, as shown at stage 706. Process 700 for aligning optical components provides a way for the optical data signal to be efficiently coupled between optical components, thus achieving a target level of data signal coupling.

In this way, embodiments of the present invention provide systems and methods for aligning optical components by matching the alignment error of opto-electronic devices within housings to eccentricities of optical elements within ports. When a housing is selected to be joined to a port, the port or housing is rotated until the optical element contained within the port is aligned with the opto-electronic device contained within the housing. Thus, optical coupling efficiency is increased as a larger amount of the data signal is coupled to the source, thereby achieving optimal transmission of an optical signal in a low cost and efficient way.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An optical sub-assembly comprising:
a housing;
an opto-electronic device located within the housing and having an alignment error relative to a reference of the housing; and
a port configured to engage the housing and including an optical element having an alignment error relative to a reference of the port, and the port being arranged for motion relative to the housing such that a predetermined motion of the port corresponds with substantial alignment of the opto-electronic device and the optical element along a predetermined axis.

2. The optical subassembly of claim 1, wherein the opto-electronic device located within the housing is one of: laser; and, photodetector.

3. The optical subassembly of claim 1, wherein the optical element is a lens.

4. The optical subassembly of claim 1, wherein the port and housing each have substantially the same error vector and error angle.

5. The optical subassembly of claim 1, wherein the optical subassembly is configured to be connected to a printed circuit board.

6. The optical subassembly of claim 1, further comprising:
a connector configured to be connected to a printed circuit board; and
signal traces electrically joined to the connector which are in electrical communication with the optical device.

7. The optical subassembly of claim 1, wherein the reference of the port is a central longitudinal axis defined by the port.

8. The optical subassembly of claim 1, wherein at least one of the housing and the port includes an indicator showing that an error vector and error angle of the port are substantially the same, respectively, as an error vector and error angle of the housing.

9. The optical subassembly of claim 1, wherein the port defines a flat that has a predetermined relationship with respect to an error angle and error vector of the port.

10. The optical subassembly of claim 9, wherein a central axis of the flat cooperates with the error vector to define the error angle, the error angle corresponding with an error angle of the housing.

11. An optical transceiver comprising:
a transceiver housing;
a printed circuit board; and
a pair of optical subassemblies disposed within the transceiver housing and connected with the printed circuit board, at least one of the optical subassemblies comprising:
a housing;
an opto-electronic device disposed within the housing and having an alignment error relative to a reference of the housing; and
a port configured to engage the housing and including an optical element having an alignment error relative to a reference of the port, and the port being arranged for rotational motion relative to the housing such that a predetermined rotation of the port corresponds with substantial alignment of the opto-electronic device and the optical element along an axis.

12. The optical transceiver of claim 11, wherein at least one of the housing and the port includes an indicator showing that an error vector and error angle of the port are substantially the same, respectively, as an error vector and error angle of the housing.

13. The optical transceiver of claim 11, wherein the port and housing each have substantially the same error vector and error angle.

14. The optical transceiver of claim 11, wherein the port includes a structure having a central axis that cooperates with an error vector of the port to define a port error angle that substantially corresponds to an error angle of the housing, and the port and the housing each having substantially the same error vector.

15. A method for aligning optical components, comprising:
determining a deviation of a first optical component relative to a first reference point in a first x-y plane;
positioning a second optical component relative to a second reference point in a second x-y plane such that the second optical component has a deviation relative to the second reference point that is substantially the same as the deviation of the first optical component relative to the first reference point; and
adjusting a position of one of the first and second optical components relative to the other until the first and second optical components are substantially aligned with each other along a predetermined axis passing through the first and second x-y planes.

16. The method of claim 15, wherein the adjusting is determined based on a calculation of an error angle of each of the first and second optical components.

17. The method of claim 15, wherein the first and second x-y planes are substantially parallel to each other.

18. The method of claim 15, wherein the position of one of the first and second optical components relative to the other is adjusted based upon a visual assessment of an optical coupling between the first and second optical components.

19. The method of claim 15, further comprising:
monitoring an output of the first optical component while adjusting the position of one of the first and second optical components; and
discontinuing adjustment of the position of one of the first and second optical components when a target level of the output of the first optical component is achieved.

20. The method of claim 15, further comprising positioning the second optical component along a z-axis using a passive alignment process.
